(19) United States
(12) Patent Application Publication
(10) Pub. No.: US 2014/0245361 A1
(43) Pub. Date: Aug. 28, 2014

(54) MULTILEVEL SATELLITE BROADCASTING SYSTEM FOR PROVIDING HIERARCHICAL SATELLITE BROADCASTING AND OPERATION METHOD OF THE SAME

(71) Applicant: Electronics and Telecommunications Research Institute, Daejeon (KR)

(72) Inventors: Jun Gil JEON, Anyang-si (KR); Joon Gyu Ryu, Daejeon (KR); Min Su Shin, Daejeon (KR); Deock Gil Oh, Daejeon (KR)

(73) Assignee: Electronics and Telecommunications Research Institute, Daejeon (KR)

(21) Appl. No.: 14/188,823

(22) Filed: Feb. 25, 2014

(30) Foreign Application Priority Data
Feb. 26, 2013 (KR) 10-2013-0020250

(51) Int. Cl. H04N 21/61; H04N 21/44; H04N 19/50

(52) U.S. Cl. CPC H04N 21/6193; H04N 19/00569; H04N 21/44
USPC 725/63

(57) ABSTRACT

Provided is a multilevel satellite broadcasting system for providing a hierarchical satellite broadcasting, including a demodulator to demodulate a transmitted multilevel compression stream based on a modulation parameter, a hierarchical video decoder to receive the demodulated multilevel compression stream, and a channel predicting and controlling unit to process at least one of channel prediction and channel control with respect to the demodulated multilevel compression stream based on channel information of the demodulator.

### CROSS-REFERENCE TO RELATED APPLICATION

This application claims the priority benefit of Korean Patent Application No. 10-2013-0020250, filed on Feb. 26, 2013, in the Korean Intellectual Property Office, the disclosure of which is incorporated herein by reference.

### BACKGROUND

1. Field of the Invention

The present invention relates to an effective hierarchical switching method of a hierarchical satellite broadcasting system to enhance availability of satellite broadcasting, and more particularly, to a technical idea of determining hierarchical switching conventionally performed in a video decoder, based on a bit error rate of a demodulator.

2. Description of the Related Art

Scalable Video Coding (SVC) technology is an extension of an H.264/Advanced Video Coding (AVC) standard which may compress a high-definition image content from at least one partial stream into a stream that may decode various resolutions, an image quality, or a refresh rate.

A SVC stream includes a single base layer capable of independent decoding and at least one enhancement layer.

The single base layer may be compatible with an H.264/AVC decoder, and the at least one enhancement layer may enhance compressibility through encoding using information of the single base layer.

Image compression may involve intra frame prediction, motion prediction, Discrete Cosine Transform (DCT), quantization, and an entropy coding process.

FIG. 1 illustrates a configuration of an SVC unit 100 according to a related art.

Due to, in a case of satellite broadcasting, building an infrastructure and broadband transmission being simpler compared to other forms of broadcasting media, satellite broadcasting is receiving attention as a medium that may satisfy demands for a greater volume of information on a broadcasting service.

Although Ka band satellite broadcasting has more available frequency resources compared to an existing Ku band satellite broadcasting system, the Ka band satellite broadcasting has a higher probability of performance deterioration due to precipitation. As an alternative means of resolving such an issue, hierarchizing a service may provide a high-quality broadcasting service in a general environment and provide a service guaranteeing basic performance even when a channel status is not favorable.

Variable Coding and Modulation (VCM) technology may optimize a transmission bandwidth and electric power by adjusting a transmission parameter, for example, modulation and coding (MODCOD) and a code rate, based on a priority of input data.

FIG. 2 illustrates a configuration of a VCM 200 according to a related art.

Grafting SVC technology and VCM technology onto satellite broadcasting may enable the use of identical content in various terminals by dividing the identical content into several layers and accordingly increase service availability.

However, in a case of an existing system, the hierarchical switching may be determined during the operation of a video decoder and accordingly surplus time between the determination and display may be short and balancing supply and demand of a single chip type commercial SVC decoder may be challenging.

### SUMMARY

According to an aspect of the present invention, there is provided a multilevel satellite broadcasting system including a demodulator to demodulate a transmitted multilevel compression stream based on a modulation parameter, a hierarchical video decoder to receive the demodulated multilevel compression stream, and a channel predicting and controlling unit to process at least one of channel prediction and channel control with respect to the demodulated multilevel compression stream, based on channel information of the demodulator.

The demodulator may support a Digital Video Broadcasting-Satellite-second generation (DVB-S2) standard.

The hierarchical video decoder may be configured to be in parallel based on at least one of a scalable video decoder and a single decoder.

The hierarchical video decoder may separate each layer of a stream and decode a plurality of original image signals from the demodulated multilevel compression stream.

The channel information of the demodulator may include a bit error rate (BER).

The channel predicting and controlling unit may verify the channel information of the demodulator and control the hierarchical video decoder to transmit an enhanced image to a display apparatus when a state in which a bit error rate of 0 is continuous in all layers over a certain interval.

The certain interval may include an instantaneous decoding refresh (IDR) interval.

The channel predicting and controlling unit may control the hierarchical video decoder to transmit a basic image, in lieu of the enhanced image when a bit error occurs in an enhancement layer.

According to another aspect of the present invention, there is provided an operation method of a multilevel satellite broadcasting system, including demodulating, by a demodulator, a transmitted multilevel compression stream based on a modulation parameter, receiving, by a hierarchical video decoder, the demodulated multilevel compression stream, and processing, by a channel predicting and controlling unit, at least one of channel prediction and channel control with respect to the demodulated compression stream based on channel information of the demodulator.

The operation method of the multilevel satellite broadcasting system may include decoding, by the hierarchical video decoder, a plurality of original image signals from the demodulated multilevel compression stream after separating each layer of a stream.

The processing may include verifying the channel information of the demodulator and controlling the hierarchical video decoder to transmit an enhanced image to a display apparatus when a state in which a bit error rate of 0 is continuous in all layers of the verified channel information over a certain interval.

The processing may include verifying the channel information and controlling the hierarchical video decoder to transmit a basic image, in lieu of the enhanced image, when a bit error occurs in an enhancement layer of the verified channel information.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a configuration of a Scalable Video Coding (SVC) unit according to a related art.

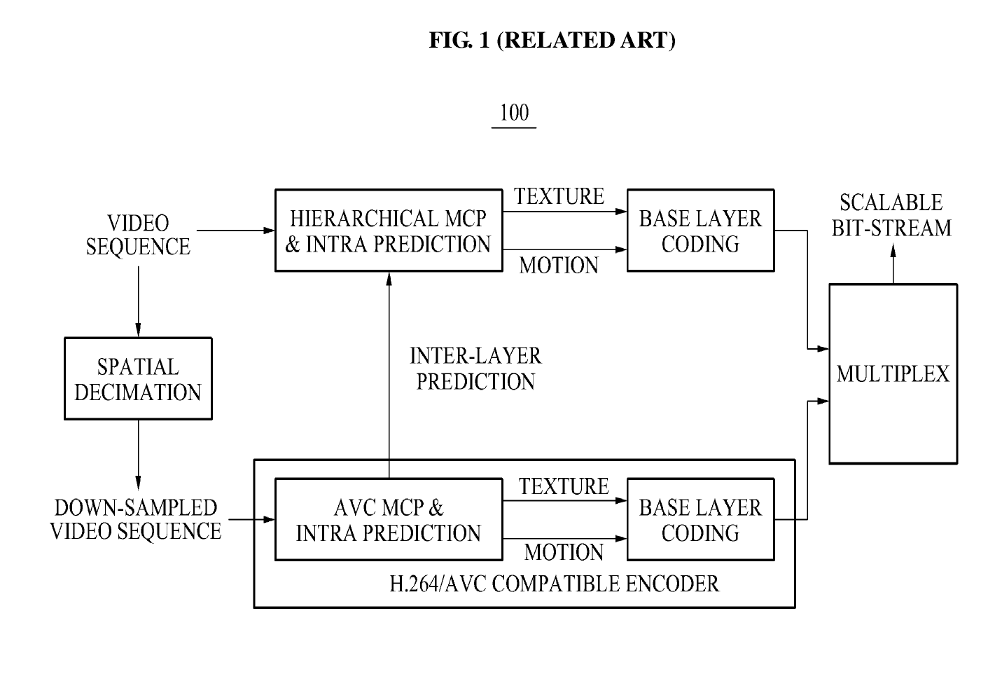

FIG. 2 illustrates a configuration of a Variable Coding and Modulation (VCM) according to a related art.

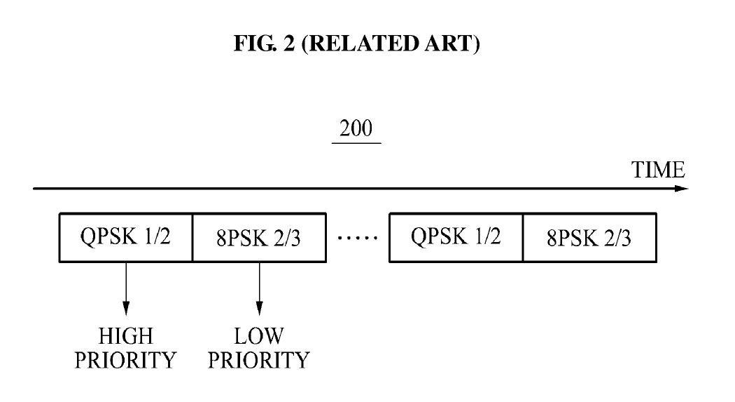

FIG. 3 is a block diagram illustrating a multilevel satellite broadcasting system according to an embodiment of the present invention.

FIG. 4 is a block diagram illustrating a multilevel satellite broadcasting system according to another embodiment of the present invention.

FIG. 5 is a flowchart illustrating an operation method of a multilevel satellite broadcasting system according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying figures, however, the present invention is not limited thereto or restricted thereby.

When it is determined detailed description related to a related known function or configuration they may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

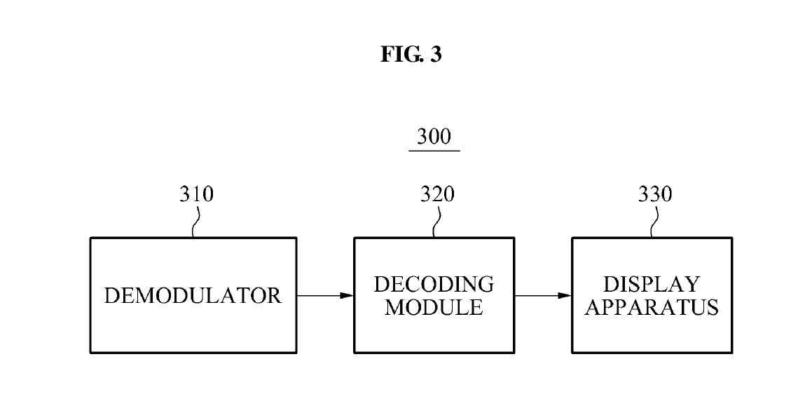

FIG. 3 is a block diagram illustrating a multilevel satellite broadcasting system 300 according to an embodiment of the present invention.

The multilevel satellite broadcasting system 300 may include a demodulator 310 and a decoding module 320.

The demodulator 310 may demodulate a transmitted multilevel compression stream based on a modulation parameter.

The demodulator 310 may support a Digital Video Broadcasting-Satellite-second generation (DVB-S2) standard, and demodulate all the transmitted multilevel compression streams based on various modulation parameters through a Variable Coding and Modulation (VCM) or an Adaptive Coding and Modulation (ACM).

The decoding module 320 may determine image quality based on channel information and transmit the determined image quality to a display apparatus 330.

The decoding module 320 may predict and control a channel prior to or concurrent with video decoding for a stable operation of a receiver and a natural hierarchal switching in the multilevel satellite broadcasting system 300.

In order to perform the above, the decoding module 320 may receive the demodulated multilevel compression stream.

The decoding module 320 may process at least one of channel prediction and channel control with respect to the demodulated multilevel compression stream based on the channel information of the demodulator 310.

The decoding module 320 may determine image quality, using at least one of the processed channel prediction and the processed channel control.

The decoding module 320 may be applicable to a parallel configuration of a scalable decoder or a single decoder.

The decoding module 320 may separate each layer based on packet ID (PID), in a case of a Moving Picture Expert Group 2 transport stream (MPEG-2 TS), and ultimately decode a plurality of original image signals from a multilevel compression stream.

The decoding module 320 may monitor a bit error rate of a demodulated signal through a control interface with the demodulator 310, for example, Inter Integrated Circuit (I2C) or RS232, and predict a current status of a channel based on the bit error rate.

The decoding module 320 may transmit an enhanced image to the display apparatus 330 when a state in which a bit error rate of 0 is continuous in all layers over a certain interval, and transmit a basic image to the display apparatus 330 when the bit error rate occurs in an enhancement layer.

Through the procedure described above, availability of a satellite broadcasting service may be enhanced.

The display apparatus 330 may receive the enhanced image or the basic image transmitted from the decoding module 320 and display the image.

The multilevel satellite broadcasting system 300 provided with the decoding module 320 may determine image quality based on channel information, and an operation method of the same will be described hereinafter.

The multilevel satellite broadcasting system 300 may provide a channel adaptive service, not only through a Scalable Video Coding (SVC) but also through a simulcast configuration.

The multilevel satellite broadcasting system 300 may decode a video more stably by separating video decoding and channel prediction.

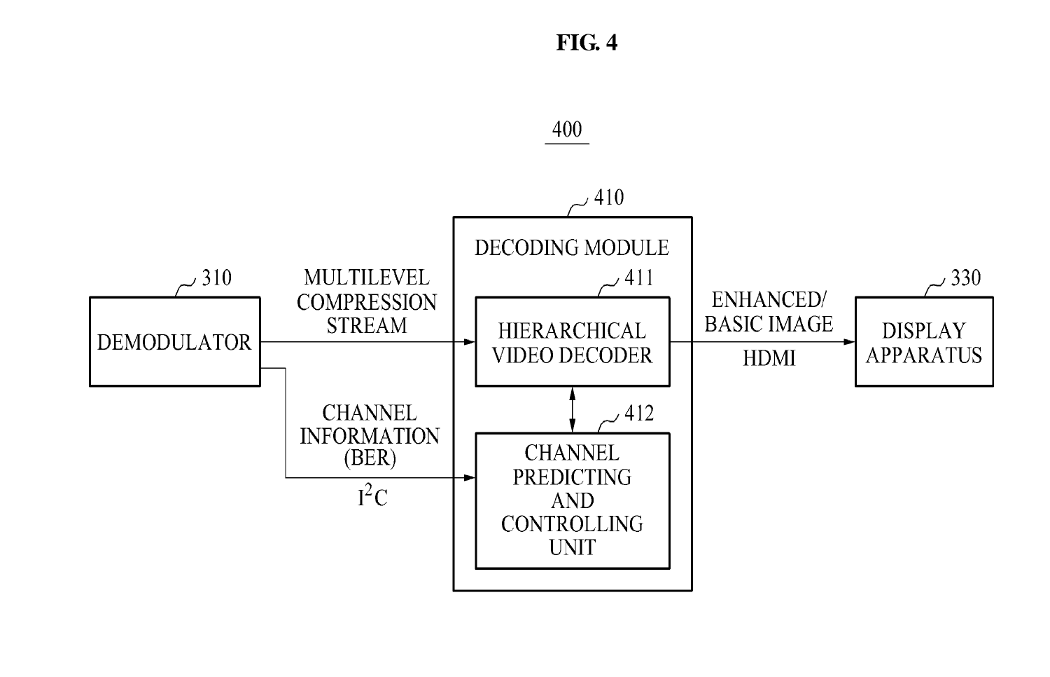

FIG. 4 is a block diagram illustrating a multilevel satellite broadcasting system 400 according to another embodiment of the present invention.

The multilevel satellite broadcasting system 400 may include a demodulator 310 and a decoding module 410.

The demodulator 310 may demodulate a transmitted multilevel compression stream based on a modulation parameter.

The demodulator 310 may support a Digital Video Broadcasting-Satellite-second generation (DVB-S2) standard, and demodulate all the transmitted compression streams based on various modulation parameters through operations of VCM or ACM.

The decoding module 410 may include a hierarchical video decoder 411 and a channel predicting and controlling unit 412.

The hierarchical video decoder 411 may receive a demodulated multilevel compression stream.

The channel predicting and controlling unit 412 may process at least one of channel prediction and channel control with respect to the demodulated multilevel compression stream based on channel information of the demodulator 310.

The demodulator 310 may support the DVB-S2 standard.

The hierarchical video decoder 411 may be configured to be in parallel based on at least one of a scalable video decoder and a single decoder.

The hierarchical video decoder 411 may separate each layer of a stream and decode a plurality of original image signals from the demodulated multilevel compression stream.

The channel information of the demodulator 310 may include a bit error rate (BER).

The channel predicting and controlling unit 412 may verify the channel information of the demodulator 310 and control the hierarchical video decoder 411 to transmit an enhanced image to a display apparatus 330 when a state in which a bit error rate of 0 is continuous in all layers over a certain interval. Here, the certain interval may include an instantaneous decoding refresh (IDR) interval.

The channel predicting and controlling unit 412 may control the hierarchical video decoder 411 to transmit a basic image, in lieu of the enhanced image, to the display apparatus 330 when a bit error occurs in an enhancement layer.

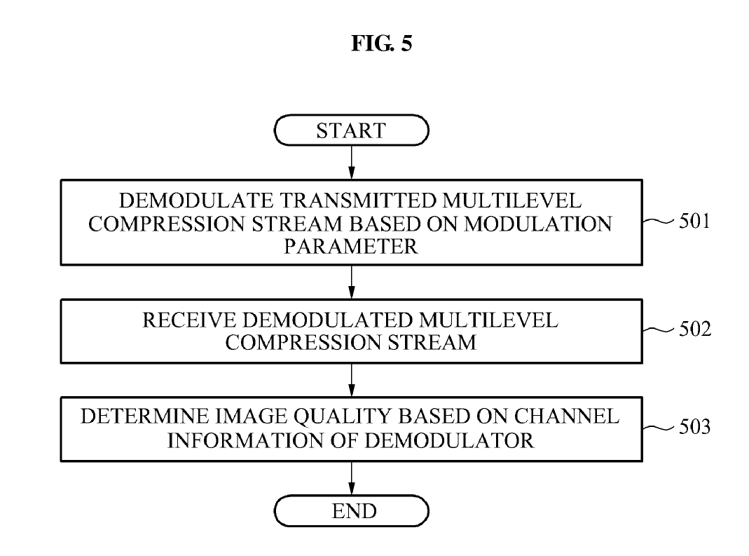

FIG. 5 is a flowchart illustrating an operation method of a multilevel satellite broadcasting system according to an embodiment of the present invention.

In operation 501, a demodulator may demodulate a transmitted multilevel compression stream based on a modulation parameter.

Through the operation method of the multilevel satellite broadcasting system, image quality may be determined by a decoding module, based on channel information.

In operation 502, a hierarchical video decoder may receive the demodulated multilevel compression stream.

In operation 503, a channel predicting and controlling unit may process at least one of channel prediction and channel control with respect to the demodulated multilevel compression stream based on the channel information of the demodulator.

To perform the processing, the operation method of the multilevel satellite broadcasting system may include verifying the channel information of the demodulator and controlling the hierarchical video decoder to transmit an enhanced image to a display apparatus when a state in which a bit error rate of 0 is continuous in all layers of the verified channel information over a certain interval.

To perform the processing, the operation method of the multilevel satellite broadcasting system may include verifying the channel information of the demodulator and controlling the hierarchical video decoder to transmit a basic image, in lieu of the enhanced image, when a state in which a bit error occurs in an enhancement layer of the verified channel information.

The operation method of the multilevel satellite broadcasting system may separate each layer of a stream and decode a plurality of original image signals from the demodulated multilevel compression stream, by the hierarchical video decoder.

According to an embodiment of the present invention, provided is a multilevel satellite broadcasting system that may determine image quality based on channel information and an operation method of the same.

According to an embodiment of the present invention, a channel adaptive service may be provided, not only through an SVC but also through a simulcast configuration.

According to an embodiment of the present invention, separating video decoding and channel prediction may enable a more stable video decoding.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A multilevel satellite broadcasting system, comprising:
a demodulator to demodulate a transmitted multilevel compression stream based on a modulation parameter;
a hierarchical video decoder to receive the demodulated multilevel compression stream; and
a channel predicting and controlling unit to process at least one of channel prediction and channel control with respect to the demodulated multilevel compression stream, based on channel information of the demodulator.

2. The multilevel satellite broadcasting system of claim 1, wherein the demodulator supports a Digital Video Broadcasting-Satellite-second generation (DVB-S2) standard.

3. The multilevel satellite broadcasting system of claim 1, wherein the hierarchical video decoder is configured to be in parallel based on at least one of a scalable video decoder and a single decoder.

4. The multilevel satellite broadcasting system of claim 1, wherein the hierarchical video decoder separates each layer of a stream and decodes a plurality of original image signals from the demodulated multilevel compression stream.

5. The multilevel satellite broadcasting system of claim 1, wherein the channel information of the demodulator comprises a bit error rate (BER).

6. The multilevel satellite broadcasting system of claim 1, wherein the channel predicting and controlling unit verifies the channel information of the demodulator and controls the hierarchical video decoder to transmit an enhanced image to a display apparatus when a state in which a bit error rate of 0 is continuous in all layers over a certain interval.

7. The multilevel satellite broadcasting system of claim 6, wherein the certain interval comprises an instantaneous decoding refresh (IDR) interval.

8. The multilevel satellite broadcasting system of claim 6, wherein the channel predicting and controlling unit controls the hierarchical video decoder to transmit a basic image, in lieu of the enhanced image, when a bit error occurs in an enhancement layer.

9. An operation method of a multilevel satellite broadcasting system, the method comprising:
demodulating, by a demodulator, a transmitted multilevel compression stream based on a modulation parameter;
receiving, by a hierarchical video decoder, the demodulated multilevel compression stream; and
processing, by a channel predicting and controlling unit, at least one of channel prediction and channel control with respect to the demodulated multilevel compression stream based on channel information of the demodulator.

10. The method of claim 9, further comprising:
decoding, by the hierarchical video decoder, a plurality of original image signals from the demodulated multilevel compression stream after separating each layer of a stream.

11. The method of claim 9, wherein the processing comprises:
verifying the channel information of the demodulator; and
controlling the hierarchical video decoder to transmit an enhanced image to a display apparatus when a state in which a bit error rate of 0 is continuous in all layers of the verified channel information over a certain interval.

12. The method of claim 9, wherein the processing comprises:
verifying the channel information of the demodulator; and
controlling the hierarchical video decoder to transmit a basic image, in lieu of an enhanced image, when a bit error occurs in an enhancement layer of the verified channel information.
